(19) United States
(12) Patent Application Publication
(10) Pub. No.: US 2008/0266553 A1
(43) Pub. Date: Oct. 30, 2008

(54) Optical Angle Detection

(76) Inventors: Andrew Maxwell Scott, Worcestershire (GB); Andrew Charles Lewin, Worcestershire (GB); Kevin Dennis Ridley, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/090,537

(22) PCT Filed: Oct. 19, 2006
(86) PCT No.: PCT/GB06/03882

§ 371 Date: Apr. 17, 2008

(30) Foreign Application Priority Data
Oct. 19, 2005 (GB) 0521253.5

(51) Int. Cl. G01B 11/26; G02F 1/01

(52) U.S. Cl. 356/141.1; 359/240

(57) ABSTRACT

Apparatus and methods for detecting angle of incidence of an optical beam. The apparatus employs two optical detectors, the first of which has placed in front of it a coating or layer which exhibits an angle-dependent optical transmission characteristic distinct from that of the light path in front of the second detector. The difference in a characteristic of the light received at the respective detectors therefore provides an indication of the angle of incidence of the light beam. The angle detector may be used particularly, though not exclusively, in conjunction with free space optical communications systems.

### FIELD OF THE INVENTION

The present invention relates to apparatus, methods, and programs for a computer for detecting angle of incidence of a beam of light, and also to systems incorporating the same. Such systems include, but are not limited to, free-space optical communications modulators and systems.

### BACKGROUND TO THE INVENTION

The potential of free-space optical communication systems is well established as a means of providing high bandwidth data links between two points on a line of sight basis. Such systems are being considered for a number of applications, notably as elements of communication links in metropolitan areas and for local area networks in open plan offices.

Co-pending patent application U.S. Ser. No. 10/483,738 (A. M. Scott et al.) discloses a dynamic optical reflector and interrogation system employing a combination of spacing-controllable etalon and a retro-reflector arranged to reflect light received via the etalon back through the etalon towards the light source.

### OBJECT OF THE INVENTION

The present invention seeks to provide apparatus, methods, and other associated aspects relating to determining angle of approach of a light beam and, optionally, making use of the angle information so determined.

### SUMMARY OF THE INVENTION

According to a first aspect of the present invention there is provided an optical detector for determining angle of incidence of a light beam of a predetermined wavelength, the detector comprising first and second detectors and an element exhibiting an angle-dependent optical transmission characteristic, the element being located in the optical path to at least one of the first and second detectors and arranged with respect to the detectors such that angle of incidence may be determined responsive to a comparison between the power of received signals of the predetermined wavelength.

The optically angle-dependent element may be located over only one of the first and second detectors.

The comparison may be a ratio of the signal strengths.

Transmissivity of the element may decrease with increase of angle of incidence from the normal.

The element exhibiting an angle-dependent optical characteristic may comprise an edge filter comprising relatively few layers whereby to exhibit a soft edge characteristic.

The element may comprise alternating layers of tantalum pentoxide and silicon dioxide.

The element may comprise 9 layers.

Transmissivity of the element may increase with increase of angle of incidence from the normal.

The optical detector may further comprise an output at which an output signal indicative of the angle of incidence is provided.

According to a further aspect of the present invention there is provided an optical modulator comprising a optical detector according to any preceding claim.

The modulator may be controlled responsive to the angle of incidence.

The invention also provides for a system for the purposes of communications which comprises one or more instances of apparatus embodying the present invention, together with other additional apparatus.

In particular, according to a further aspect of the present invention there is provided a free space optical communication system comprising an optical detector or modulator according to any preceding aspect.

The invention is also directed to methods by which the described apparatus operates and including method steps for carrying out every function of the apparatus.

In particular, according to a further aspect of the present invention there is provided a method of determining angle of incidence of a light beam, the method comprising comparing signal strengths from a common source signal by means of two detectors, the light arriving at one of the detectors via a filter element exhibiting an angle-dependent transmission characteristic, and determining the angle of incidence responsive to a comparison between the two detected signal strengths.

According to a further aspect of the present invention there is provided an method of controlling an optical modulator the method comprising the steps of: providing an optical detector according to the first aspect; controlling the modulator responsive to the angle of incidence detected by the optical detector.

The invention also provides for computer software in a machine-readable form and arranged, in operation, to carry out or control every function of the apparatus and/or methods.

In particular, according to a further aspect of the present invention there is provided a program for a computer, the program comprising the steps of: receiving from an optical detector according to the present invention a signal indicative of angle of incidence of a received light beam; controlling the modulation of an optical modulator responsive to the signal indicative of angle of incidence.

The invention is also directed to signals employed by the other aspects of the invention.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1(a) shows a perspective view of a typical micro-mirror element and typical spring structures in accordance with the present invention (substrate not shown);

FIG. 1(b) shows a side view of the micro-mirror element and typical spring structures according to the present invention

FIG. 1(c) shows a plan view of an array of micro-mirror elements according to the present invention;

FIG. 2 shows a schematic graph of separation between micro-mirror and substrate versus time according to the present invention;

FIG. 3(a) shows a schematic graph of transmission characteristics of an optical modulator according to the present invention for a normal angle of incidence;

FIG. 3(b) shows a schematic graph of transmission characteristics of an optical modulator according to the present invention for a 60 degree angle of incidence;

FIG. 4 shows a schematic graph of dynamic response over time of a modulator in accordance with the present invention;

FIG. 5 shows a schematic graph comparing applied voltage with transmitted signal in accordance with the present invention;

FIG. 6 shows a schematic diagram of a first modulator arrangement in accordance with the present invention;

FIG. 7 shows a schematic diagram of a second modulator arrangement in accordance with the present invention;

FIG. 8 shows a schematic diagram of a third modulator arrangement in accordance with the present invention incorporating of a retro-reflector;

FIG. 9(a) shows a schematic diagram of a fourth modulator arrangement in accordance with the present invention incorporating a retro-reflector;

FIG. 9(b) shows a schematic diagram of a fifth modulator arrangement in accordance with the present invention incorporating a retro-reflector;

FIG. 9(c) shows a schematic diagram of a system in accordance with the present invention;

FIG. 10 shows a flow chart of a modulation method in accordance with the present invention.

FIG. 11 shows a schematic diagram of a first detector in accordance with the present invention;

FIG. 12(a) shows a schematic graph of angle detector transmission with respect to angle of incidence in accordance with the present invention;

FIG. 12(b) shows a schematic graph of optimum spacing versus angle in accordance with the present invention;

FIG. 13(a) shows a further schematic graph of angle detector transmission with respect to angle of incidence in accordance with the present invention;

FIG. 13(b) shows a schematic graph of contrast between logic 1 and logic zero according to the present invention;

FIG. 14 shows an example of displacement of mirror with respect to angle of incidence according to the present invention;

FIG. 15(a) shows a schematic diagram of a first optical detector according to the present invention;

FIG. 15(b) shows a schematic diagram of a first optical detector according to the present invention;

FIG. 16 shows a schematic graph of transmission characteristics of a filter element in accordance with the present invention;

FIG. 17 shows a schematic graph of the variation of transmission ratio with angle of incidence according to the present invention.

### DETAILED DESCRIPTION OF INVENTION

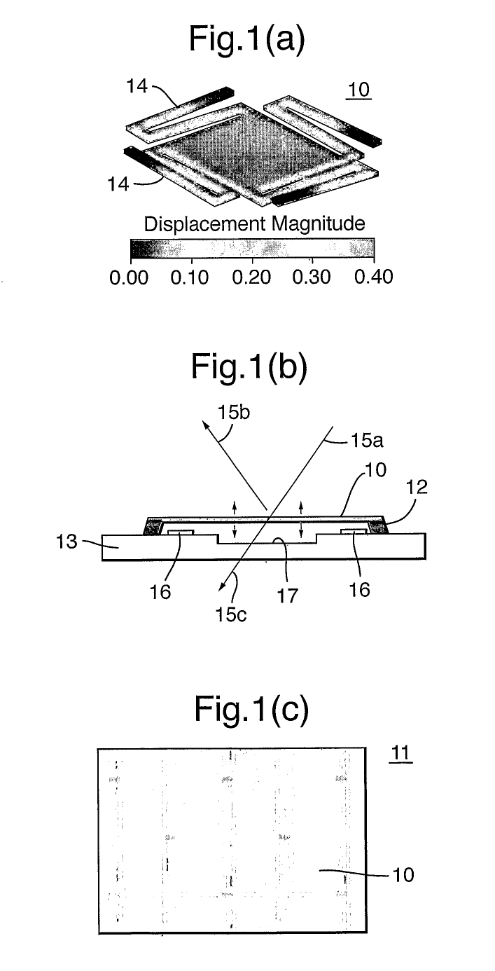

Referring to FIGS. 1(a-c) a modulator that may be used for controlling the intensity of a beam (or beams) of light is based on a single element 10 or an array 11 of MOEMS mirror structures in which one or more micro-mirrors 10 are suspended 12 above a substrate 13. This arrangement may be used in transmission for wavelengths where the substrate (for example silicon) is optically transmissive, and may be used in reflection for a substantially larger range of wavelengths.

An individual element comprises a micro-mirror 10 which is suspended above a substrate 13 by a distance of between a fraction of a micron and a few microns. The micro-mirror is supported by springs 14, so that when a voltage is applied between the substrate and the micro-mirror, electrostatic forces will pull the micro-mirror from an equilibrium position (without voltage applied) towards the substrate.

In voltage-actuated electrostatic devices, below a given threshold the electrostatic force balances the mechanical restoring force due to the device displacement and the device is in a stable equilibrium condition. Above this threshold, the device becomes unstable as the electrostatic force exceeds the restoring force and the micro-mirror moves uncontrollably towards the substrate—a condition commonly known as “latch”, “pull-in” or “pull-down”. Applying a voltage above the threshold enables a larger range of mirror motion for a given drive voltage—typically by a factor of approximately 3 over a sub-threshold regime.

The micro-mirror may be any shape in plan form but is should be substantially flat and parallel to the substrate. The micro-mirror may conveniently be square but may also be of other shapes. Shapes which afford close packing in an array are particularly preferred: for example triangular, rectangular, and hexagonal.

When light 15a is directed onto this device, some of the light will be reflected 15b and some will be transmitted 15c to the substrate and out the other side (for the case of wavelengths such that the substrate is transparent). Light reflected and transmitted by the suspended mirror will interfere with light reflected and transmitted by the substrate, and the actual transmission and reflection of the device will vary between a high and a low value depending on the angle of incidence of the light upon the device, on the spacing between the suspended mirror and the substrate, and on other pre-determined characteristics of the system such as the thickness of the suspended micro-mirror, the refractive index of the material from which the micro-mirror is made, and the wavelength of the incident light.

In operation, as the spacing between micro-mirror and substrate changes, the transmission varies between a high and low value, providing a means of modulation of the incident light. The modulation can work in transmission or reflection modes. It is noted that the micro-mirror is typically a fraction of a micron thick and will be semi-transparent even in the visible region where silicon is highly absorbing, so a modulator made from silicon can be used in reflection for the visible band. Materials other than silicon, for example silicon dioxide or silicon nitride may also be used as would be apparent to the skilled person. In this case the substrate would be required to be transparent (and might for example be silicon dioxide or silicon nitride, and the micro-mirror and bottom layer would be silicon dioxide or silicon nitride or a thin layer of silicon or a combination of materials.

The transmission and reflection properties of the modulator can be described by using the known formulae for transmission and reflection by a Fabry-Perot etalon, as given in equation 2 of this document. It is noted that the reflected and transmitted light experiences a phase shift as well as a change in amplitude. This can also be used in a device which is required to modulate the phase of a beam of light.

When the micro-mirrors are produced as an array with an extended area covered by a tiling of closely packed mirrors, it becomes a Spatial Light Modulator (SLM). In an SLM the micro-mirrors may be controlled individually, in groups, or all together. Preferably the elements of the micro-mirror array are arranged or operated to move coherently: that is they are arranged to move synchronously with the same timing and amplitude, so that the resulting phase of light across the array is uniform; for the groups of multiple micro-mirrors, and possibly all, elements move together, to create a substantially uniform effect on parts of the wavefront incident upon the device. This has the benefit that the diffraction properties of the modulated light are determined by the extended wavefront and not by the diffraction by a single micro-mirror element. An array of small mirrors enables high speeds to be reached whilst maintaining good mirror flatness when compared to larger devices.

The micro-mirrors are each actuated between two stable positions in which one can be confident of ensuring the mirror is located when being controlled using two voltage states. The first of these is an ‘equilibrium position’ in which the micro-mirror 10 is suspended at rest above the substrate when no voltage (or a voltage below a given threshold) is applied between the mirror and the substrate. In embodiments in which no voltage is applied there is no extension of the support springs 14. In an alternative embodiment, a sub-threshold voltage is applied to reduce overall modulator power consumption by recharging a power cell when the state of the modulator is changed. The mirror will settle to a lower equilibrium position as the electrostatic and mechanical forces balance between the original equilibrium position (no voltage applied) and the substrate.

The second is the “pull-down” position in which the applied voltage exceeds the threshold, causing the micro-mirror to be pulled firmly down towards the substrate.

Insulating stops (for example bosses or other raised electrically insulating features) 16 may be provided between the substrate and the micro-mirror so that when the voltage exceeds the threshold value the mirror is pulled hard against the stops but cannot be pulled any further towards the substrate. These pull-down stops thereby prevent undesirable electrical contact between the micro-mirror and the substrate, since electrical contract would lead to a short circuit and electrical damage. Moreover, incorporating one or more end stops enables a pre-defined offset between the mirror and the substrate to be defined when in the pull-down position. Additionally, they provide mechanical damping, speeding the settling time. Advantageously, this offset may be specifically designed to correspond to a low transmission state over a wide angular range. Preferably the end stops are arranged to enable a small degree of bow to be built into the mirror in the pull-down position to provide additional energy to overcome any adhesion energy in the mechanical contact. In one possible embodiment, a substantially square or rectangular mirror incorporates end stops at or close to each corner of the mirror and at or close to the centre of the mirror.

The mirrors may be realised using a MEMS process, preferably a polysilicon surface micromachining process. Preferably, the end stops are realised using one or more bushes 16 (insulated islands) on the substrate and a dimple 17 under the mirror. More preferably the bushes may comprise silicon nitride and/or polysilicon and the mirror and dimple comprise polysilicon.

When a small voltage is applied to the micro-mirror, it will move a small amount from its equilibrium position. When the voltage exceeds a certain threshold, the motion becomes unstable, and the micro-mirror will snap down to the ‘pull-down position’. It is difficult to apply an analogue control voltage to make the micro-mirror move to an arbitrary distance from the substrate, requiring fine control over the voltage and being susceptible to any voltage drops due to track length differences between mirrors in an array. In normal or simple control systems, one can only move the micro-mirror about one third of the way between the equilibrium position and the pull-down position under analogue control; thereafter the micro-mirror will dynamically move fully to the pull-down position. In practice this snap-down position is preferred in the present invention in which it is preferred to switch the micro-mirror between the equilibrium position and the pull-down position using two discrete voltage states.

When the micro-mirror is subjected to a force resulting from an applied voltage signal, the motion is determined by the mechanical resonance frequency of the mirror and the damping effect of the atmosphere. The mirror together with its spring system behaves as a classical resonator, with a resonant frequency which can be determined by conventional commercially available software tools. The precise resonant frequency for a given arrangement will depend on the strength of the spring and the mass of the mirror and the degree of damping. For typical structures of, for example, two straight springs and a mirror size of 25 micron×25 microns, this resonant frequency may be of the order of 300 kHz. Larger mirrors may have substantially lower resonant frequencies. Devices with stiffer springs may have substantially higher resonant frequencies.

At atmospheric pressure and at pressures down to a few tens of millibar, air causes the motion of the micro-mirrors to be heavily damped, and the time taken to change between states is dominated by this damping process. At a pressure of a few millibar or less, the micro-mirror behaves as a high-Q resonator: that is, it moves in a strongly oscillatory manner. This oscillation is not exhibited when the mirror is pulled down and held against the pull-down stops since they provide mechanical damping, but is evident when the micro-mirror is released from its pull-down position by switching the applied voltage to zero (or otherwise below the threshold required to retain it in the pull-down position).

When a micro-mirror is released in a vacuum, it will spring up towards its equilibrium position, and subsequently oscillate about this position, returning to close to the pull-down position after each cycle. This may be very weakly damped, and the motion will then proceed in a very predictable fashion in which the amplitude and the frequency are relatively independent of the precise degree of vacuum or the absolute voltage that was used initially to hold the micro-mirror down.

The displacement of the micro-mirror above the substrate is given by:

x(t)=x₀−(x₀−x₁)cos(Ωt)exp(−βt) (1)

where x is the distance from the substrate to the micro-mirror, x₀ is the equilibrium position, x₁ is the pull-down position, t is the time from release of the micro-mirror, Ω is the resonant frequency, and β is the damping coefficient.

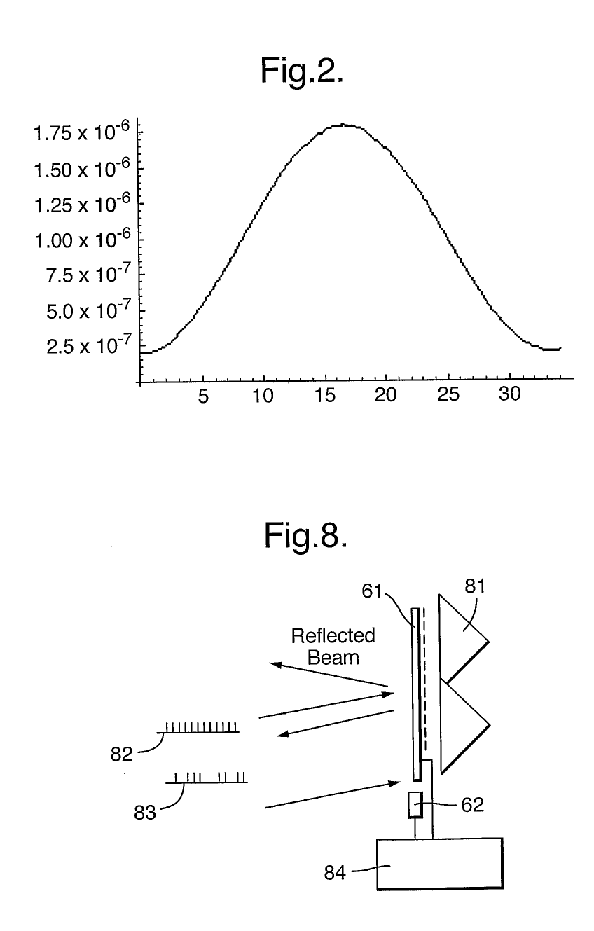

At low pressure the oscillation has a low damping coefficient and will exhibit an overshoot, so that for a maximum required plate separation (between micro-mirror and substrate) of 1.5 microns, for example, it is possible to design the equilibrium position to be close to 0.75 microns and rely on the overshoot to achieve the required maximum separation. The full range of plate separations is addressed in the first half cycle as the etalon moves from minimum to maximum separation from the substrate. After a time between a half period and a full period, the substrate voltage is reapplied, and as the plate continues the oscillation it moves back towards the substrate, where the micro-mirror is recaptured by the applied field and returns to the initial ‘pull down’ position. A typical plate separation with respect to time over one cycle is as shown in FIG. 2, in which the horizontal axis denotes time (in arbitrary units) and the vertical axis shows displacement of the micro-mirror from the substrate. The equilibrium position in the example shown is 1 micron. One may alternatively allow the micro-mirror to make a pre-determined number (1, 2, 3, or more) of oscillations and then re-apply the voltage to recapture the micro-mirror in the pull-down position.

By controlling the release timing of the micro-mirror in this way, control of the mirror position across the whole range of motion may be made dependent on timing control rather than fine voltage control. Such fine control of timing may be achieved using high speed digital electronics (e.g. 0.35 micron CMOS).

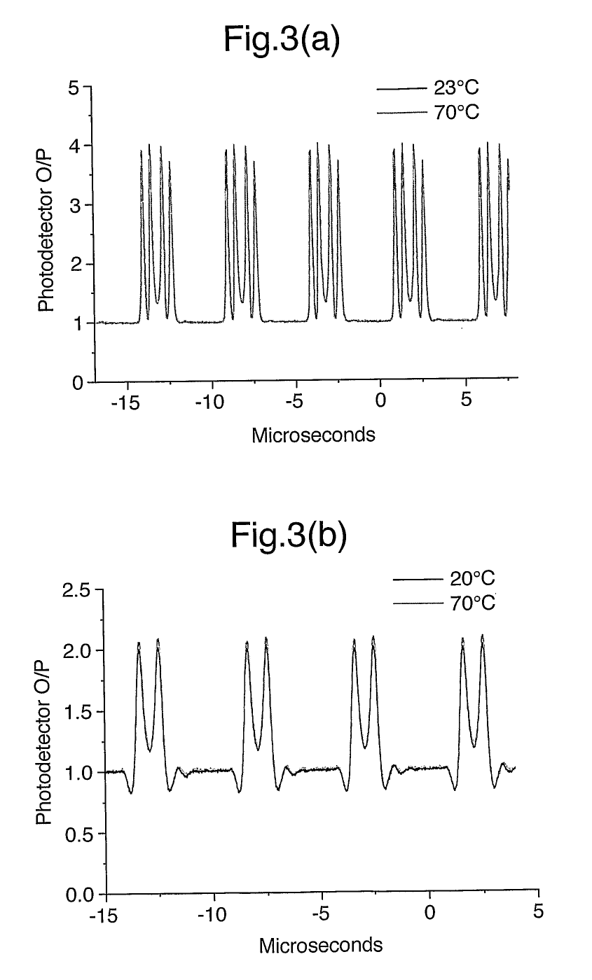

Referring now to FIGS. 3(a) and 3(b), it is possible—using the formulae for transmission and reflection in a Fabry Perot etalon (equation 2 gives the transmission) in conjunction with the equation for the separation between micro-mirror and substrate over time—to determine the transmission through the micro-mirror versus time when the spacing of the etalon mirrors follows the time dependence as shown in FIGS. 3(a) and 3(b). FIG. 3(a) shows experimental transmission data for normal incidence whilst FIG. 3(b) shows the corresponding data for a 60 degree angle of incidence. Once again the horizontal axis denotes time whilst the vertical axis denotes optical transmission through the micro-mirror.

In the first example shown, for light incident normal to the plane of the etalon, two transmission peaks occur as the micro-mirror rises away from the substrate and a corresponding two peaks as it is drawn back towards the substrate. The second example shows that at 60 degrees there is one transmission peak as the micro-mirror moves to maximum displacement and a second as it returns to the pull down position. However the timing and number of peaks varies with angle of incidence of the light beam so that it is highly desirable to know the angle of incidence in order to optimise etalon timing. Each graph shows the transmission characteristics at two temperatures (of approximately 20 degrees and 70 degrees) showing a good degree of consistency between those two operating values.

Alternatively, measurements of the oscillation pattern may be used to determine the angle of incidence of light on the modulator. (In practice one derives a measurement of cos(θ), where θ is the angle of incidence)

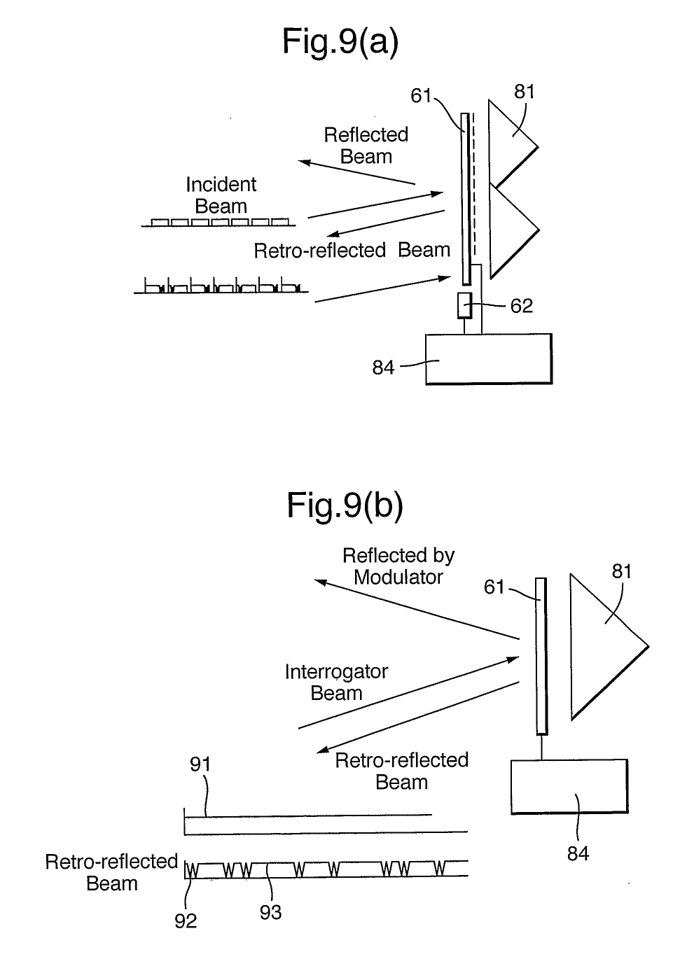

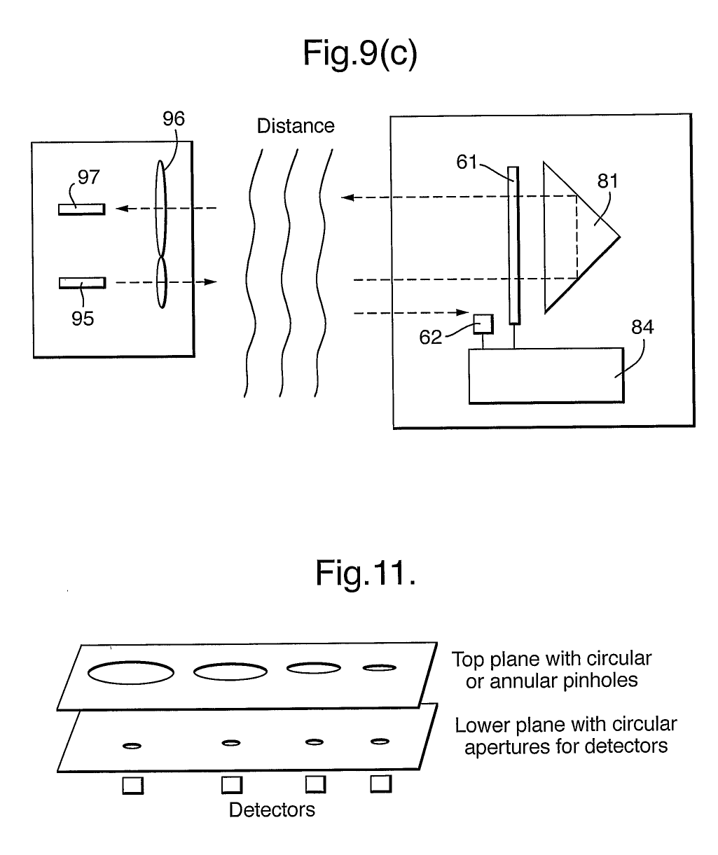

This device may be used to control a continuous wave (cw) laser (or a laser with a predictable pulse pattern) providing that the detector system can resolve the dynamic modulation produced by the modulator. (FIGS. 9(b) and 9(c)). Alternatively it may be used to control a repetitively pulsed laser (FIG. 9(a)) providing that the pulse duration is substantially shorter than the oscillation period of the micro-mirror. In this case the detector in the interrogator system (new FIG.—10 or 9c) does not need to be able to resolve the dynamic behaviour of the modulator but only has to resolve the individual pulses of the interrogator. A timing circuit may be used, which may consist of a detector detecting arrival times of incident pulses, the timing of which is used to predict the precise arrival time of a subsequent pulse. The micro-mirror is held in the pull-down position and then may be released at a time calculated such that the micro-mirror system will be in a position to apply the desired amount of modulation to the pulse at the time the laser pulse is predicted to arrive.

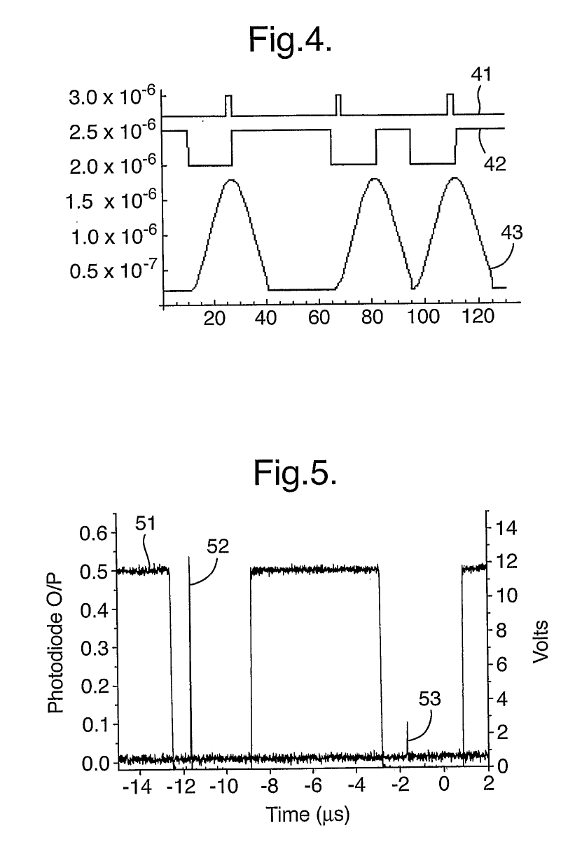

Referring now to FIG. 4 the dynamic response of the etalon is shown versus time (clock pulses). The top trace 41 represents incoming laser pulses (arbitrary units); the middle trace 42 shows voltage applied to micro-mirror (pull-down voltage corresponds to “2.5×10⁻⁶”, 0V corresponds to “2×10⁻⁶”), the bottom trace 43 shows spacing between substrate and MEOMS mirror (scale in metres).

If a laser pulse arrives near maximum displacement (first and third pulses) then transmission is maximum and logic 1 transmitted. If a laser pulse arrives when the mirror is close to the substrate (second pulse) then transmission is minimum and logic zero is transmitted.

Referring now to FIG. 5, experimental data is illustrated for the case in which trace 51 shows the micro-mirror drive voltage, and 52-53 show the transmitted power of two laser pulses. The delay between the release of the micro-mirror and the arrival of the first pulse is such that the transmission is high 52. The delay between the release of the micro-mirror and the arrival of the second pulse is such that the transmission is low 52.

The modulator may be used with a retro-reflector, a detector and drive electronics to form a transponder that can communicate with a remote interrogator system as illustrated in FIG. 9(c). On the right the transponder is illustrated, while on the left, there is shown a laser 95 with a collimating lens 98, and a detector 97 with a collecting lens 96. If the transponder is sufficiently far away that light from the transponder diffracts and spreads so that it does not just return to the laser interrogator, but also spills over and passes into the receiver optics, then the detector will detect whatever light is reflected back from the transponder. In this case the interrogator will detect the modulation produced by the remote transponder.

The modulation imposed on the received pulses may be amplitude modulation, or phase modulation, or both together.

In a truly cw interrogator, the transponder may not need a detector and may simply transmit a modulating pattern for any interrogator to detect. It may alternatively use a detector to detect the presence of interrogator light. In a quasi-cw modulated interrogator, the transponder detector may use the timing information in the interrogator beam (e.g. intensity spikes or breaks in intensity) to synchronise the modulation with respect to the timing information. In the case of an interrogator producing a series of short pulses, then the transponder may detect the arrival of one pulse and use this timing information to determine the optimum timing to produce modulation of the next pulse. The optimum release time may be determined by, for example, detecting arrival of one pulse and collecting information on the angle of arrival, and then using a look-up table to determine the optimum delay. As an example, the system could be used to switch the transmission or reflection of the pulse between a maximum and a minimum value, or it may be used to control the amplitude of pulses so that they are all of the same intensity or so that they are coded in some way. One can do this in the first half cycle of the oscillation. One may alternatively do this at any predictable point during the mechanical oscillation, or one may even allow the micro-mirror to make two oscillations and achieve modulation of a pulse in the second oscillation (which is significant if one wishes to achieve full duplex communication).

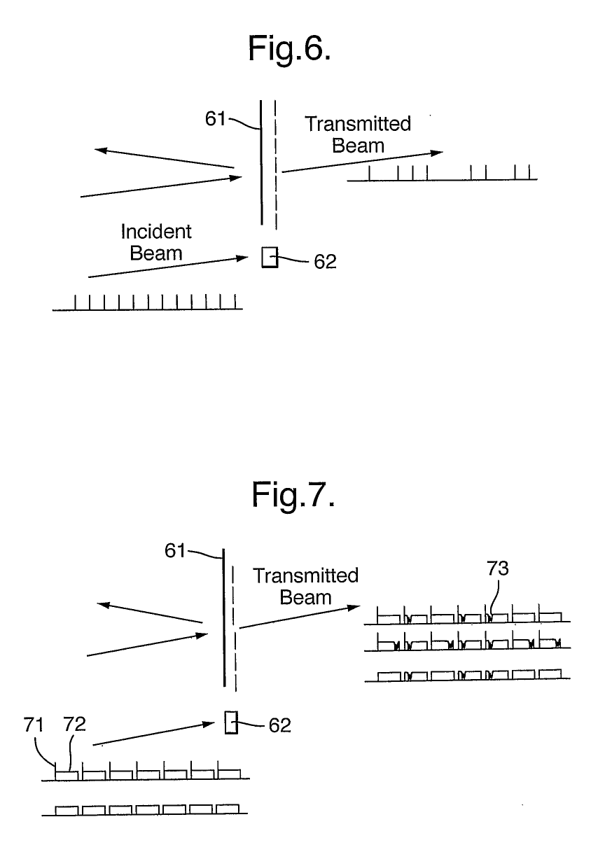

Referring now to FIG. 6, the modulator 61 may therefore have a detector 62 associated with it so that it can detect the arrival of one pulse and use this information to release the micro-mirror in order to modulate the subsequent pulse.

Referring now to FIG. 7, in a variation of the above scheme the remote laser illuminator may consist of a repetitively short-pulsed laser system combined with a long pulse or continuous wave laser system. In this arrangement the short pulse may be used as a timing pulse. The modulator may use the short pulse for timing, and then impart a modulation on the continuous wave or long pulse part of the illumination. The modulated beam may then be encoded by, for example, a time shift of the modulation relative to the timing pulse. If the interrogator has a sufficiently fast detector or sensitive detector then it may not be necessary to have any timing information on the interrogator beam and no detector on the transponder. The interrogator detector may either detect the time resolved modulation, or may detect the small fast change ion the average retro-reflected power.

FIG. 7 schematically shows interrogation of a modulator 61 with a laser pulse comprising a timing pulse 71 and a quasi-cw laser pulse 72. The quasi-cw part is modulated 73; one can either code the beam by modulating or not modulating each pulse; or else one can choose to modulate or apply a time-delayed modulation. One can either use an initial timing pulse or one can use the rising edge of a rectangular-wave interrogation pulse (see examples lower left). Examples of the modulated pulses are shown middle right.

Referring now to FIG. 8, the modulator 61 may be combined with a retro-reflector 81 and thereby act as a modulated retro-reflector. Whilst the modulator micro-mirror elements may, by way of example, be of the order of 25 μm across the elements of the retro-reflector may be considerably larger, for example 5-15 mm across. Providing the individual micro-mirrors move coherently, the divergence of light passing through the modulator will be determined by the overall array size and not by the divergence due to diffraction by a single micro-mirror. The use of relatively large retro-reflecting elements assists in forming a strongly collimated beam of reflected light. The modulated retro-reflector device may then be illuminated by a laser interrogator transmitting a pattern of pulses 82. The modulated retro-reflector device will then modulate the incoming pulses and retro-reflect the pulses 83 back to the interrogator. In this the interrogator pulses are essentially pulsed and the retro-reflected light is either wholly retro-reflected or wholly attenuated. The interrogator may then receive the retro-reflected pulses and decode them as a series of ‘1’s and ‘0’s. This modulator arrangement may use a detector 62 to detect pulses, and use a control unit 84 to predict the arrival time of subsequent pulses, using the detection of one pulse to determine the time to release a micro-mirror in order to modulate a subsequent pulse. In this case the angle of arrival on the retro-reflector will have to be controlled; alternatively the retro-reflecting system may use some form of angle detection to determine the optimum timing for the micro-mirror release.

Alternatively the combined system of interrogator and retro-reflecting modulator system may optimise performance. The modulator may be operated at a fixed time delay and the interrogator may determine the angle of arrival and vary the timing of pulses so that optimum modulation occurs.

The optimum timing for the modulator to produce a maximum or minimum signal will be angle dependent. If the above system is to work for light incident at any angle then the detector should preferably incorporate a means of determining the angle of arrival since optimum mirror timing depends upon angle of incidence of the incident light. Alternatively the interrogator may incorporate a means of estimating the angle of incidence on the tag and change the timing of pulses on the tag to ensure maximum modulation.

Referring now to FIGS. 9(a) and 9(b), alternatively one may use a modulated retro-reflector device together with an interrogator which may (or may not) transmit a set of short timing pulses together with quasi-continuous lower-intensity pulses. The modulating retro-reflector device may then modulate the quasi-continuous lower intensity pulse at some controlled time after the timing pulse. The device will retro-reflect this power back to the interrogator. In this arrangement the interrogator pulses comprise a modulation with a quasi CW period, and the retro-reflected light is synchronised with the pulsed element of the interrogator but the modulation is applied to the quasi-cw region of the interrogator illumination.

The precise modulation pattern received by the interrogator will depend on the angle of arrival on the retro-reflecting device, but the interrogator may be able to recognise the particular pattern and from this it will be able to determine the optimum time delay relative to timing pulse, and if desired, the angle of incidence.

By measuring the quasi-continuous waveform and its timing relative to the timing pulses, the interrogator will be able to determine the size of the time shift applied to the waveform, and hence interpret this as a piece of data. An advantage of this latter approach is that the modulator arrangement does not need to have an angle detector integrated into it, allowing it to be more compact and to be manufactured more cheaply.

Referring now to FIG. 9(b) the interrogator may produce a continuous illumination 91 and the retro-reflected light may then be modulated 92, 93 without synchronisation linked to the interrogator.

Referring now to FIG. 9(c) an overall system comprises a one or more modulator arrangements as described above together with an interrogator laser system, which incorporates a transmitter 95 and a receiver telescope 96 coupled to a detector 97.

In a first angle measurement mode, the interrogator transmits a continuous wave beam, and measures the retro-reflected light from the transponder. The transponder operates in a ‘release and catch’ mode, possibly without the use of any cue from the interrogator. For each ‘release & catch’ cycle, the retro-reflection detector will detect a signal qualitatively similar to that shown in FIG. 3, i.e. comprising a series of relatively well defined maxima and minima. By measuring over several pulses and integrating the detector will be able to accumulate a well-resolved curve. The timing of the peaks of these curves is a function of the cosine of the angle of incidence on the transponder, as is the depth or height of the central peak or trough, and by suitable fitting and processing of the data, it will be possible to determine the cosine of the angle of incidence on the modulator.

In a second embodiment of the angle measurement mode, the interrogator transmits a series of pulses and measures the retro-reflected light from the transponder. The transponder operates in a ‘release and catch’ mode, initiating the release time a fixed time delay after detecting a pulse from the interrogator. For each ‘release & catch’ cycle, the retro-reflection detector will detect a pulse from the transponder and it may record the amplitude of each pulse. If the interrogator slowly varies the timing between pulses so that the time delay between pulse N and pulse N+1 equals the time delay between pulse N−1 and pulse N plus some increment Dt, then each pulse will be modulated by a different part of the response curve of the modulator, and over a period of several pulses the interrogator will stroboscopically sample the whole transmission profile of the modulator. This data will enable the interrogator to infer the angle of incidence on the transponder.

In a first communication mode, the interrogator uses a train of pulses to interrogate the modulator arrangement. The modulator arrangement detects the timing of the incoming signal and the angle from an angle detector. From the time-history of the past set of pulses, the modulator arrangement is able to predict the arrival time of the next pulse. Using an internal clock and a look-up table it releases the micro-mirror array at such a time that the modulator provides a maximum or minimum transmission of the next pulse when it arrives. Alternatively, minimum transmission may be obtained by simply holding the micro-mirrors in the pull-down position. The receiver detects pulses which it determines to be either logic 1 or logic 0. This mode will give performance over a maximum range.

In a second communication mode, the interrogator may (or may not) send a series of timing pulses (or a series of square pulses with sharp edges that can be used for timing purposes). This may be superimposed on a quasi continuous interrogation power. The modulator arrangement detects the timing of timing pulses, but does not attempt to determine the angle of arrival. It operates the ‘release & catch’ mechanism in one of two ways: it either modulates the pulse to indicate a logic one, and does not modulate to indicate a logic zero (or vice versa), or else it modulates at one of two preset time delays to indicate either logic one or logic zero. The advantage of the former is that a low bandwidth detector can detect modest changes in transmission which indicate whether or not modulation has been applied. The advantage of the latter technique is that it positively indicates detection of logic one and logic zero.

Alternatively, for true cw interrogation 91, one can detect either the presence 92 or absence 93 of modulation, or the presence of time-key shifted modulation, providing the interrogator can detect the modest change in signal strength that is expected if the signal integration time is slow compared with the high frequency components in the modulation signal.

The interrogator receives the timing pulse and the analogue return. Irrespective of the angle of arrival it is able to recognise the timing of the analogue return by reference to the retro-reflected timing pulse.

In a remote angle detection mode the goal is to determine the angle of incidence on a remote modulator arrangement. This may be useful for determining, for example, in which direction an interrogator should move in order to maximise the signal from the modulator arrangement, or to determine the orientation of the modulator. The interrogator illuminates the modulator with a quasi cw beam and detects the time resolved retro-reflection when the micro-mirrors are released and caught. By matching the detected signal to a template, the processor can identify the template corresponding to a particular angle of incidence.

In an intensity stabilisation mode, the goal is to stabilise the average of an output beam when the input beam is fluctuating on a timescale which is slow compared with the repetition rate (for example owing to scintillation). The incident power is incident on a modulator which is synchronised to provide a particular degree of attenuation. When there are fluctuations in the incident power, small timing changes can be made to the release time of the micro-mirrors so that the attenuation is adjusted, thereby ensuring that the overall laser power is maintained at a constant value If the incoming beam is, for example, a string of logic 1 and logic 0 pulses, with a more slowly varying intensity fluctuation caused by scintillation, then the system could be modulated so that the slowly varying fluctuation was removed by the stabilisation, but the more rapid variation between logic 1 and logic 0 remained and could be detected later. This approach may be used in place of a detector with a large dynamic range in order to detect the signal in a free-space optical laser communications system.

In a spatial light modulator mode, then groups of micro-mirrors on an array are released so as to produce a spatial pattern across the beam. This may be used for various applications where other spatial light modulators are currently used, including for example signal processing and beam steering.

In a beam steering mode, if one controls the release time of each individual element then one can effectively control the phase on each element of the micro-mirror array. By controlling the phase of each element, the propagation direction can be controlled. Thus this may be used to steer a laser beam in a predetermined direction, provided each micro-mirror can be individually controlled.

Considering the characteristics of the Fabry-Perot etalon in more detail, the transmission of the MOEMS mirror-substrate modulator may be modelled by considering the system as a simple structure with two reflecting surfaces, the reflection coefficient being determined by the Fresnel reflection equations applied to silicon. The transmission of a Fabry Perot etalon is given by:

$${T}_{etalon} = \frac{{T}^{2}}{{( 1 - R )}^{2}} \frac{1}{1 + \frac{4 R}{( 1 - R )} {sin}^{2} ( \frac{φ}{2} )} ; \\ where \\ φ = \frac{4 π}{λ} L cos θ \qquad ( 2 )$$

in which the spacing between the plates is given by L, the angle of incidence is given by θ and the wavelength is λ. The reflectivity of each surface is given by R and the transmission is given by T.

If we consider the combination of the modulator and a corner cube retro-reflector, then we note that the reflected light will be determined by the combination of the two polarisation components. We consider the case where the interrogator is circularly polarised or depolarised, so that there are equal intensities of the two polarisations, whatever the angle of arrival. The incident light will have equal amounts of ‘s’ (E vector parallel to surface) and ‘p’ polarised light (E vector in plane of transmitted and reflected beams). Each polarisation is transmitted by different amounts, and the part polarised beam enters the corner cube retro-reflector. This will become depolarised by a variable amount, depending on the nature of the retro-reflector. If the corner cube retro-reflector is metal coated then the polarisation properties will be preserved. If it relies on dielectric materials it will be significantly depolarised for certain angles. In the latter case it is assumed as an approximation that the beam is fully depolarised by the corner cube. The depolarised beam makes a second pass back through the etalon and returns to its source.

Thus the modulated retro-reflection is taken to be

$${C}_{retro} = \frac{{( {T}_{s} + {T}_{p} )}^{2}}{4} {R}_{cc} \qquad ( 3 )$$

where Cᵣₑₜᵣₒ is the component of the retro-reflection, Tₛ and Tₚ are the transmission for the s and p polarisations respectively and R_{cc} is the reflectivity of the corner cube.

It is noted in passing that the phase ψ of the transmitted light is given by the relation:

$$ψ = Arg \{ \frac{1}{1 - R exp ( iφ )} \} ; \\ where \\ φ = \frac{4 π}{λ} L cos θ \qquad ( 4 )$$

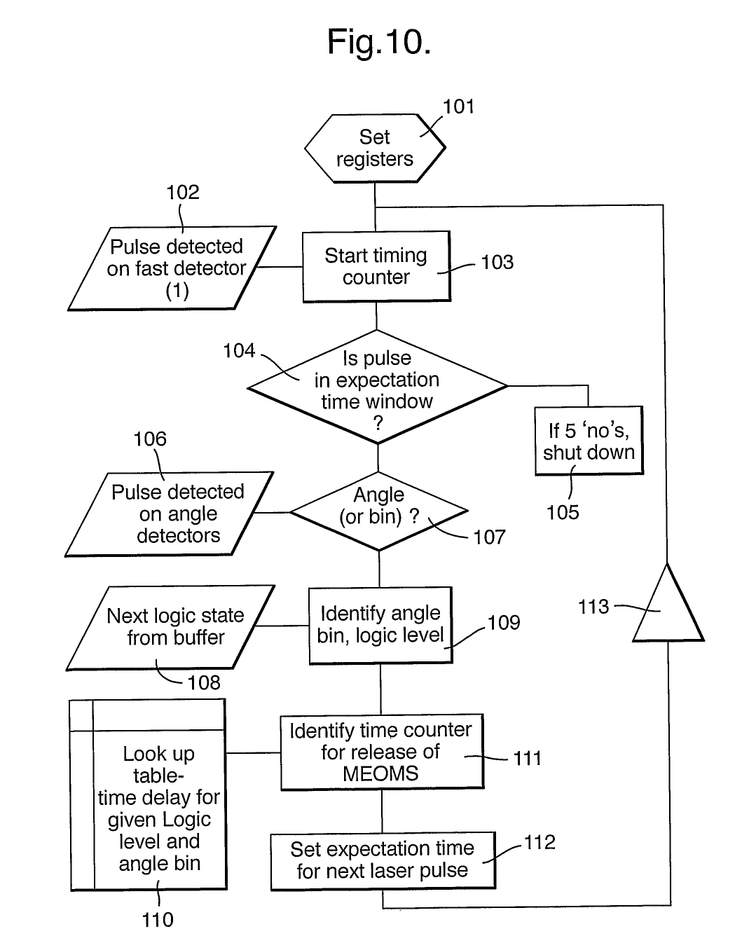

Referring now to FIG. 10, there is shown a logic diagram for control of a modulator micro-mirror. Local registers are initialised 101 and when a timing pulse is detected 102 the timing counter is started 103. If the pulse arrives in the expectation time window 104 then the angle or angle range (or angle range or “bin”) is determined 106-109. A release time for the micro-mirror 111 and expected arrival time for the next pulse 112 are then determined responsive to the established angle of incidence. This may conveniently make use of a look-up table 110. The process is then repeated 113 for the new expectation window. If the modulator repeatedly fails to receive pulses in the expectation window then it may terminate 105 or take other appropriate action.

An angle detector may be required so that the system can optimise the modulator for a given arrival angle of incidence. Two examples are described below.

Referring now to FIG. 11 a first device identifies the angle detector as belonging to one of several ‘angle bins’

The detector comprises a number (typically six) of detectors, located below a substrate. The substrate has a non-transmitting coating on the upper surface and the apertures are annuli or discs of different sizes. On the lower surface, there is no coating except near the detector element, where there are masked areas obscuring the detectors, with pinhole apertures of a uniform size. The detectors are each placed below one of the apertures on the lower surface.

The alignment of an annulus on the upper surface with a hole on the lower surface is such that light will only pass through the pairs of apertures to the underlying detector if the light is incident within a given range of angles of incidence. The range of angles for which light can pass through is determined by the inner and outer diameters of the annulus on the top surface, the thickness and refractive index of the substrate, and the diameter of the lower hole in the substrate. There is no coating except near the detector element, so that light does not experience multiple reflections before entering the diode aperture since that would creates an erroneous angle signal.

For a substrate with a thickness of up to 2 mm, and feature sizes of order 50 micron or larger, modelling indicates that the transmission through the detector is determined by geometrical considerations, with diffraction being relatively minor.

A uniform flux of F J/m² incident on the surface at angle θᵢ is transmitted through an annulus on the top surface, with inner radius r₁ and outer radius r₂. The transmitted flux is given by:

$${E}_{trans 1} = π F \{ {r}_{2}^{2} - {r}_{1}^{2} \} cos {θ}_{i} \cdot T ( {θ}_{i} ) \qquad ( 5 )$$

In the above the effect of foreshortening introduces the factor cos θᵢ and the angle dependent transmission is explicitly incorporated as T(θᵢ).

The pattern of the top annulus forms a shadow on the lower surface, with the centre of the annulus located at a position

d=w tan(θᵣ) (6)

where w is the thickness of the substrate, and θᵣ is the angle of refraction inside the substrate.

The transmission through the lower aperture with radius r₃ is given by the Boolean overlap integral.

Modelling of this indicates that the best angular resolution is achieved when the substrate thickness has a low refractive index and the thickness is maximised. It is also found that it is best to have a slight overlap of the ‘angle bins’ so that in the transition between one bin and the next, the detector noise is minimised.

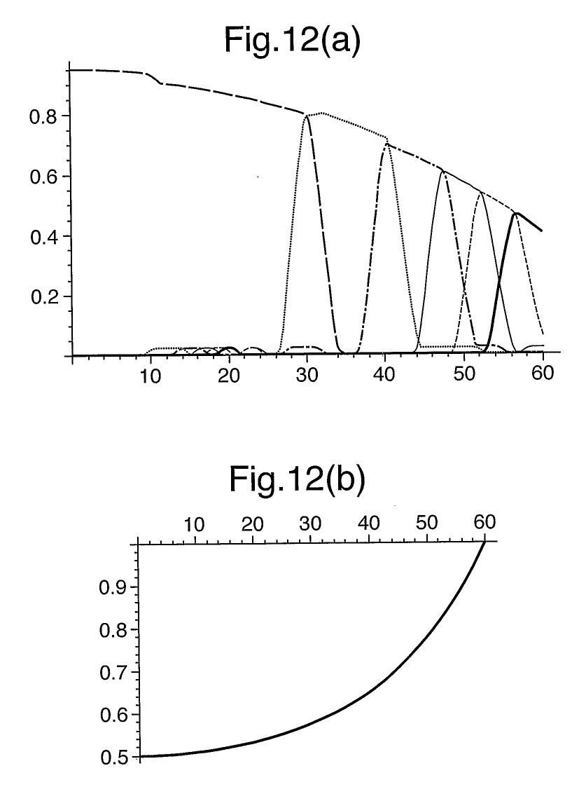

Referring now to FIG. 12(a) modelling of angle detector transmission in the case of 2 mm thick silica and 100 micron thick feature size reveals that there is a slight overlap in sensitivity to maximise the signal on the detector close to the overlap point

When silicon was modelled, it was found that very poor resolution is achieved, particularly at large angles. This is because the strong refraction bends all light to wards the normal, and a 5 degree difference in angle of arrival in air is reduced to a very small difference in displacement of the annulus shadow on the lower surface. Most recent modelling using a 1.5 mm thick substrate indicates that this is also successful. The maximum annulus diameter is 1.4 mm for a 2 mm substrate.

It has been shown that for any given angle of arrival, several detectors may record a signal. It is proposed that the tag identifies the strongest signal and uses this as the indicator for the particular angle bin. This will be subject to three sources of error. Variations in detector sensitivity will lead to an error in the boundary between two angle bins. Turbulence may cause the intensity to become de-correlated over small distances, and the intensity on one annulus may be different from the intensity on another. Finally, the solar flux may be incident as a DC flux on one detector, and this may modify the sensitivity of the associated detector.

It has been noted that there is a need to adjust the etalon spacing according to the angle of incidence. The simplest way of doing this is to identify a set of etalon spacings that can practically be addressed, and from this identify the appropriate ‘angle bin’ for each specific spacing. Analysing the transmission of an etalon:

$${T}_{total}^{2} = {\{ \frac{{T}^{2}}{{( 1 - R )}^{2} + 4 R {sin}^{2} ( \frac{2 π}{λ} L cos θ )} \}}^{2} \\ Peakat \frac{2 π}{λ} L cos θ = \frac{π}{2} \\ Forgiven L ; peakwhen θ = arc cos \{ \frac{λ}{4 L} \} \qquad ( 8 )$$

FIG. 12(b) shows a plot of the optimum spacing L versus angle θ.

It can be seen that if a set of uniformly distributed spacings are selected, then the angular range for each spacing will vary. As an example we select six spacings, with the following angular ranges.

TABLE 1

| Angular range (degree) | Spacing (Logic 0) | Spacing (Logic 1) |
|---|---|---|
| 0-31 | 0.4 | 0.81 |
| 31-41 | 0.4 | 0.94 |
| 41-48 | 0.6 | 1.06 |
| 48-53 | 0.6 | 1.19 |
| 53-57 | 0.6 | 1.31 |
| 57-6 | 0.8 | 1.44 |

Using these angle bins we consider the case where the reflectivity is determined by the Fresnel reflectivity of uncoated silicon.

The Fresnel reflectivity is given by

$${R}_{⊥} = {\{ \frac{{( \sqrt{{n}^{2} - {sin}^{2} θ} - cos θ )}^{2}}{{n}^{2} - 1} \}}^{2} ; \\ {R}_{∥} = \{ \frac{{n}^{2} cos θ - \sqrt{{n}^{2} - {sin}^{2} θ}}{{n}^{2} cos θ + \sqrt{{n}^{2} - {sin}^{2} θ}} \} \qquad ( 9 )$$

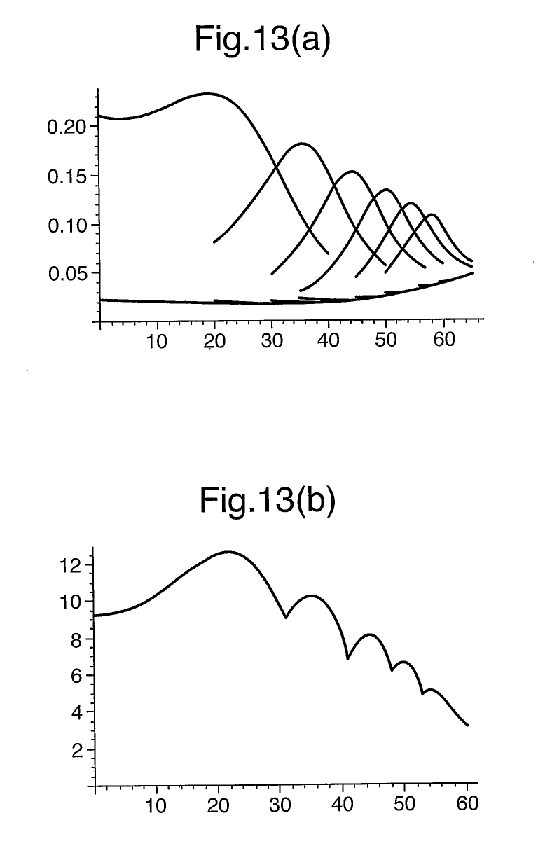

Referring now to FIG. 13(a), using these reflectivities and the set of etalon spacings given in the table above, we can compute the transmission versus angle for the various spacings. The figure shows a plot of retro-reflected signal versus angle for spacings corresponding to logic 1 and logic 0; reflectivity determined by Fresnel reflection coefficient.

Referring now to FIG. 13(b) the contrast between the logic 1 and logic 0 levels is computed for a simple etalon based on Fresnel reflection by two silicon surfaces.

The results show a contrast coefficient of approximately 9-12 close to normal incidence, dropping to 3 near 60 degree. The drop occurs because the reflectivity for the parallel polarisation drops as the angle of incidence approaches Brewster's angle, and the finesse of the etalon for that polarisation drops. As a result, the transmission for the ‘logic 0’ state is anomalously high. This indicates that the etalon structure needs to be more sophisticated than the simple etalon structure discussed here.

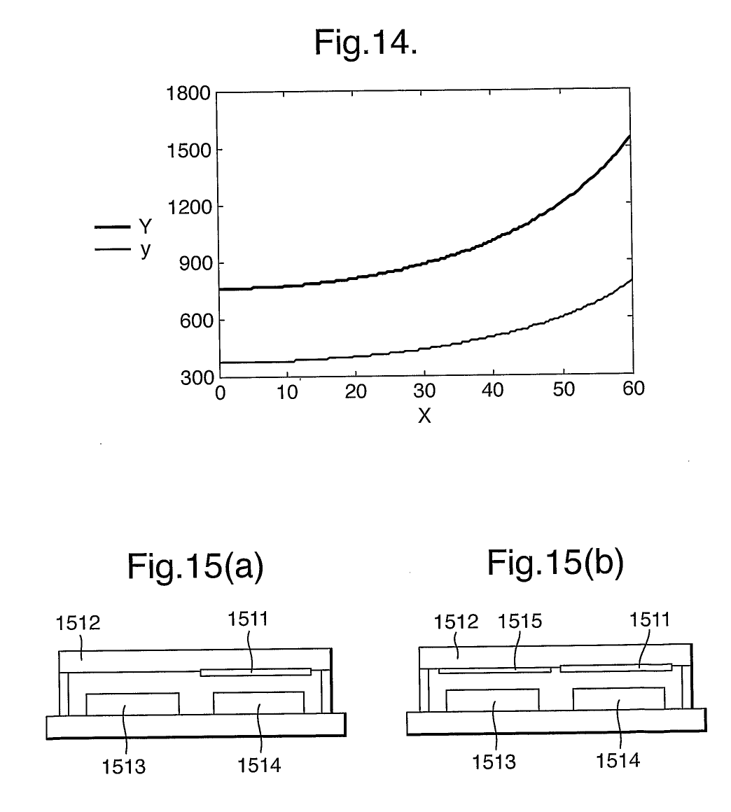

Referring now to FIG. 14 it is shown how the displacement of the moving mirror for the maximum and minimum signal varies as the angle of incidence is increased from 0-60°. By taking this into account, the release timing of the mirror may be optimised for maximum transmission or retro-reflection.

Referring now to FIG. 15(a) a second embodiment of an optical angle detector comprises two detectors 1513-1514 and a window 1512 which covers both. One of the detectors 1514 has a filter element 1511 (comprising, for example, one or more coatings or layers) having an angle-dependent transmission characteristic and located in the optical path approaching the detector. This coating covers one detector 1514 but not the second 1513, and the device works by measuring the ratio between the strength of optical signals received at each of the two detectors. A lookup table may be employed to establish the corresponding angle of arrival.

In other embodiments other arrangements may be employed. In general, coatings and layers may be located in front of both detectors provided that the difference (or ratio) between the optical signals received at the respective detectors exhibits an angle-dependent characteristic.

Undesirable interference effects may be mitigated by ensuring that the window 1512 is not parallel to the surface of the detectors 1513, 1514.

Referring now to FIG. 17, the ratio of the two detectors is shown as a function of angle of incidence. It is seen that, in the example illustrated, the ratio increases approximately quadratically as the angle of incidence relative to the normal is increased from 0 to 60 degree. This variation can therefore be used to determine the angle of incidence with whatever resolution is required, subject to noise and variations in detector sensitivity.

It is noted that in preferred embodiments the incident light beam should be un-polarised or circularly polarised, so that there are equal amplitudes of the s and p components in the incident light. Otherwise the detector will be sensitive to the polarisation direction as well as angle of incidence of the light.

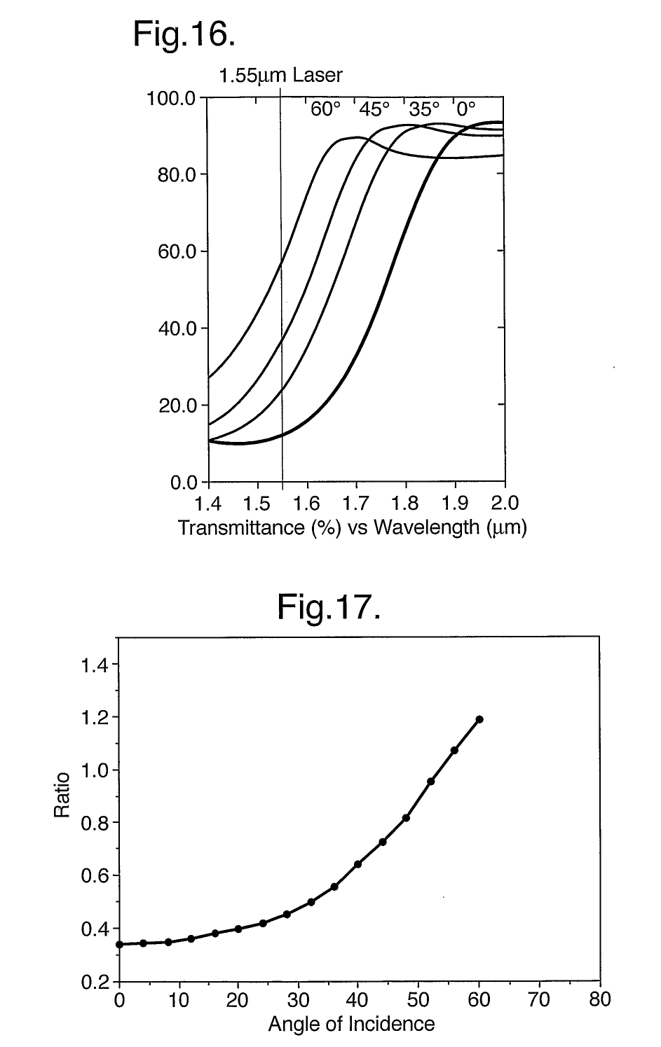

Referring now to FIG. 16 the transmission characteristics of an edge-filter based design for use as the element with angle-dependent transmission are shown. The edge-filter based design exhibits the feature that, when the filter element is tilted with respect to the incident light, the curve of transmission versus wavelength changes so that, for incident light of a given fixed wavelength, the transmission through the element varies. In this instance the filter design is basically that of a quarter-wave dielectric mirror with relatively few repeats of the basic high/low pair of layers. This gives it a relatively “soft” edge so that a gradual response results with angular tilt, thereby enhancing the ability to determine angle of incidence. The filter coating may consist, for example, of 9 alternating layers of tantalum pentoxide and silicon dioxide (in that order). However other combinations of materials that give a similar high/low refractive index pair of layers could be used, optionally based on known edge-filter designs. A conventional edge-filter would have many more repeats and a hard edge response which would change more rapidly with respect to angle and make it more difficult to determine incidence angles unambiguously.

Referring now to FIG. 17, the ratio between the values measured by the two detectors is seen to vary as the angle of incidence upon the filter element varies. The use of two detectors ensures that the ‘angle signal’ is independent of laser power or laser pulse energy.

It is noted that ratio shown in FIG. 17 varies with angle with the same ‘quadratic shape’ that the optimum spacing of a MEOMS micro-mirror based modulator shows with angle (FIG. 14), this means that the sensitivity of the present angle detector (low near normal incidence and high near 60 degrees) is well matched to the general requirement for determining the angle, namely little accuracy required at normal incidence and higher accuracy as the angle of incidence approaches 60 degrees.

Referring now to FIG. 15(b), whilst in the embodiments described above transmission through the filter decreases with increase in angle of incidence from the normal, it will be apparent to the skilled person that a filter having the opposite characteristic with respect to angle of incidence could also be used: that is a filter in which transmission increases as angle of incidence increase from the normal. Furthermore an arrangement in which filters 1511, 1515 of opposite transmission characteristic are located above respective detectors 1514, 1513 may be employed to provide further angular discrimination. In such a case the change in the received power ratio of the signals as detected at the two detectors will take on a wider range of values compared to the case of the single filter of FIG. 15(a).

Any range or device value given herein may be extended or altered without losing the effect sought, as will be apparent to the skilled person for an understanding of the teachings herein.

1. An optical detector for determining angle of incidence of a light beam of a predetermined wavelength, the detector comprising first and second detectors and an element exhibiting an angle-dependent optical transmission characteristic, the element being located in the optical path to at least one of the first and second detectors and arranged with respect to the detectors such that angle of incidence may be determined responsive to a comparison between the power of received signals of the predetermined wavelength.

2. An optical detector according to claim 1 in which an optically angle-dependent element is located over only one of the first and second detectors.

3. An optical detector according to claim 1 in which the comparison is a ratio of the signal strengths.

4. An optical detector according to claim 1 in which transmissivity of the element decreases with increase of angle of incidence from the normal.

5. An optical detector according to claim 1 in which the element exhibiting an angle-dependent optical characteristic comprises an edge filter comprising relatively few layers whereby to exhibit a soft edge characteristic.

6. An optical detector according to claim 1 in which the element comprises alternating layers of tantalum pentoxide and silicon dioxide.

7. An optical detector according to claim 6 comprising 9 layers.

8. An optical detector according to claim 1 in which transmissivity of the element increases with increase of angle of incidence from the normal.

9. An optical detector according to claim 1 in which the element is located in the path to the first detector and in which transmissivity of the element decreases with increase of angle of incidence from the normal, the optical detector further comprising a second element exhibiting an angle-dependent optical transmission characteristic, the second element being located in the optical path to the second detector, and wherein transmissivity of the second element increases with angle of incidence from the normal.

10. An optical detector according to claim 1 further comprising an output at which an output signal indicative of the angle of incidence is provided.

11. An optical modulator comprising a optical detector according to claim 1.

12. An optical modulator according to claim 11 in which the modulator is controlled responsive to the angle of incidence.

13. A free space optical communication system comprising an optical detector according to claim 1.

14. A method of determining angle of incidence of a light beam, the method comprising comparing signal strengths from a common source signal by means of two detectors, the light arriving at one of the detectors via a filter element exhibiting an angle-dependent transmission characteristic, and determining the angle of incidence responsive to a comparison between the two detected signal strengths.

15. A method of controlling an optical modulator the method comprising the steps of:
providing an optical detector according to claim 1
controlling the modulator responsive to the angle of incidence detected by the optical detector.

16. A computer readable medium including a program for a computer, the program performing steps comprising of:
receiving from an optical detector according to claim 1 a signal indicative of angle of incidence of a received light beam;
controlling the modulation of an optical modulator responsive to the signal indicative of angle of incidence.

17-20. (canceled)
